(19) United States
(12) Patent Application Publication
(10) Pub. No.: US 2009/0147189 A1
(43) Pub. Date: Jun. 11, 2009

(54) DISPLAY PANEL

(75) Inventors: Hyun-Young KIM, Suwon-si (KR); Joo-Sun Yoon, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/263,730

(22) Filed: Nov. 3, 2008

(30) Foreign Application Priority Data
Dec. 6, 2007 (KR) 10-2007-0126052

(51) Int. Cl. G02F 1/1335

(52) U.S. Cl. 349/106

(57) ABSTRACT

In a display panel, an array substrate includes a pixel electrode disposed in a pixel area and a switching element connected to the pixel electrode. A color filter substrate is combined with the array substrate. The color filter substrate includes a light-blocking layer, a color filter layer, and a common electrode. The color filter layer is disposed on the light-blocking layer. The common electrode is disposed on the color filter layer. The common electrode has an opening disposed in the pixel area and extending along the longitudinal direction. The opening has left, right, upper and lower sides and a plurality of notch parts disposed at the upper and lower sides. An outermost notch part is spaced apart from the left side or the right side by 20 μm to 30 μm.

### CROSS-REFERENCE TO RELATED APPLICATION

The present application claims priority from and the benefit of Korean Patent Application No. 10-2007-0126052, filed on Dec. 6, 2007, which is hereby incorporated by reference for all purposes as if fully set forth herein.

### BACKGROUND OF THE INVENTION

1. Field of the Invention

The present invention relates to a display panel. More particularly, the present invention relates to a display panel used for a display device.

2. Discussion of the Background

A liquid crystal display (LCD) panel includes a lower substrate, an upper substrate, and a liquid crystal layer. The lower substrate includes a thin-film transistor (TFT) that performs switching to drive each pixel. The upper substrate includes a common electrode. The liquid crystal layer is sealed between the lower substrate and the upper substrate. An electric field is applied to the liquid crystal layer to control the light transmittance of the liquid crystal layer, so that the LCD panel displays an image.

In the case of a mobile communication terminal, the LCD panel may include a plurality of pixels. The LCD panel may include red, green, and blue pixels.

Also, in order to increase a viewing angle, an electric field between the common electrode of the upper substrate and a pixel electrode of the lower substrate may be distorted to form multiple domains in the liquid crystal layer.

When multiple domains are formed in the liquid crystal layer, image deterioration, such as afterimages, spots, etc., may occur on the LCD panel. When a black grayscale level is changed to a white grayscale level or when a high grayscale level, for example, greater than about 200, is changed to the white grayscale level, the alignment of liquid crystal molecules may be distorted so that luminance differences at various viewing angles are increased, thereby forming the afterimages. In addition, the alignment of the liquid crystal molecules may be affected by a vacuum during a chip-on-glass (COG) process, a pressure difference between the substrate and portions of a polarizer, or a pressure difference between the substrate and a touch panel, so that spots may be displayed on the LCD panel.

### SUMMARY OF THE INVENTION

The present invention provides a display panel that may improve image display quality.

Additional features of the invention will be set forth in the description which follows, and in part will be apparent from the description, or may be learned by practice of the invention.

The present invention discloses a display panel including an array substrate and a color filter substrate. The array substrate includes a pixel electrode disposed in a pixel area and a switching element connected to the pixel electrode. The pixel area has a longitudinal side along a longitudinal direction of the array substrate and a horizontal side along a horizontal direction of the array substrate. The color filter substrate is combined with the array substrate. The color filter substrate includes a light-blocking layer, a color filter layer, and a common electrode. The light-blocking layer defines a transmission area corresponding to the pixel area. The color filter layer is disposed on the light-blocking layer. The color filter layer may be disposed on the light-blocking layer and in the transmission area. The common electrode is disposed on the color filter layer. The common electrode has an opening disposed in the pixel area and extending along the longitudinal direction. The opening has left, right, upper, and lower sides and a plurality of notch parts at the upper and lower sides. An outermost notch part is spaced apart from the left side or the right side by 20 μm to 30 μm.

The present invention also discloses a display panel including an array substrate and a color filter substrate. The array substrate includes a pixel electrode disposed in a pixel area and a switching element connected to the pixel electrode. The pixel area has a longitudinal side along a longitudinal direction of the array substrate and a horizontal side along a horizontal direction of the array substrate. The color filter substrate is combined with the array substrate. The color filter substrate includes a light-blocking layer, a color filter layer, and a common electrode. The light-blocking layer defines a transmission area corresponding to the pixel area. The color filter layer is disposed on the light-blocking layer. The common electrode is disposed on the color filter layer. The common electrode has an opening disposed in the pixel area and extending along the longitudinal direction. The opening has left, right, upper, and lower sides and a plurality of notch parts at the upper and lower sides. Both of the left and right sides of the opening have either a recessed shape or a protruded shape.

The present invention also discloses a display panel including an array substrate and a color filter substrate. The array substrate includes a pixel electrode disposed in a pixel area and a switching element connected to the pixel electrode. The pixel area has a longitudinal side along a longitudinal direction of the array substrate and a horizontal side along a horizontal direction of the array substrate. The color filter substrate is combined with the array substrate. The color filter substrate includes a light-blocking layer, a color filter layer, a common electrode, and an island-shaped protrusion. The light-blocking layer defines a transmission area corresponding to the pixel area. The color filter layer is disposed on the light-blocking layer. The common electrode is disposed on the color filter layer. The common electrode has an opening disposed in the pixel area and extending along the longitudinal direction. The opening has left, right, upper, and lower sides and a plurality of notch parts at the upper and lower sides. The island-shaped protrusion is disposed on the color filter layer and at a location corresponding to a location of the switching element.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing a display panel in accordance with one exemplary embodiment of the present invention.

FIG. 2 is a cross-sectional view taken along line I-I′ shown in FIG. 1.

FIG. 3A and FIG. 3B are plan views showing a color filter substrate shown in FIG. 1.

FIG. 4 is a cross-sectional view showing a display panel in accordance with another exemplary embodiment of the present invention.

FIG. 5 is a plan view of the color filter substrate shown in FIG. 4.

FIG. 6A and FIG. 6B are plan views showing a color filter substrate in accordance with still another exemplary embodiment of the present invention.

FIG. 7A and FIG. 7B are plan views showing a color filter substrate in accordance with further still another exemplary embodiment of the present invention.

FIG. 8 is a plan view showing a color filter substrate in accordance with further still another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to,” or “coupled to” another element or layer, it can be directly on, connected or coupled to the other element or layer or intervening elements or layers may be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

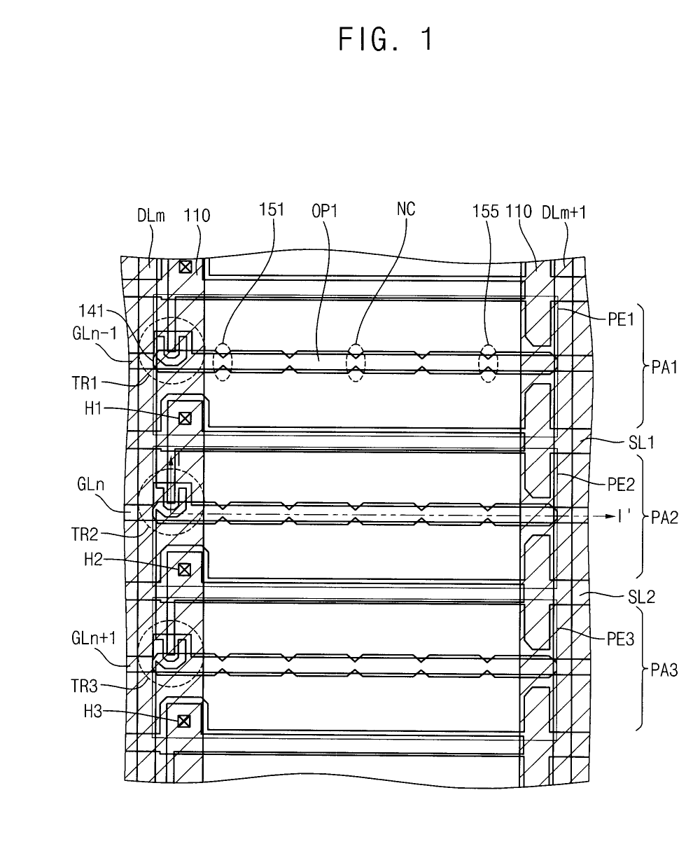

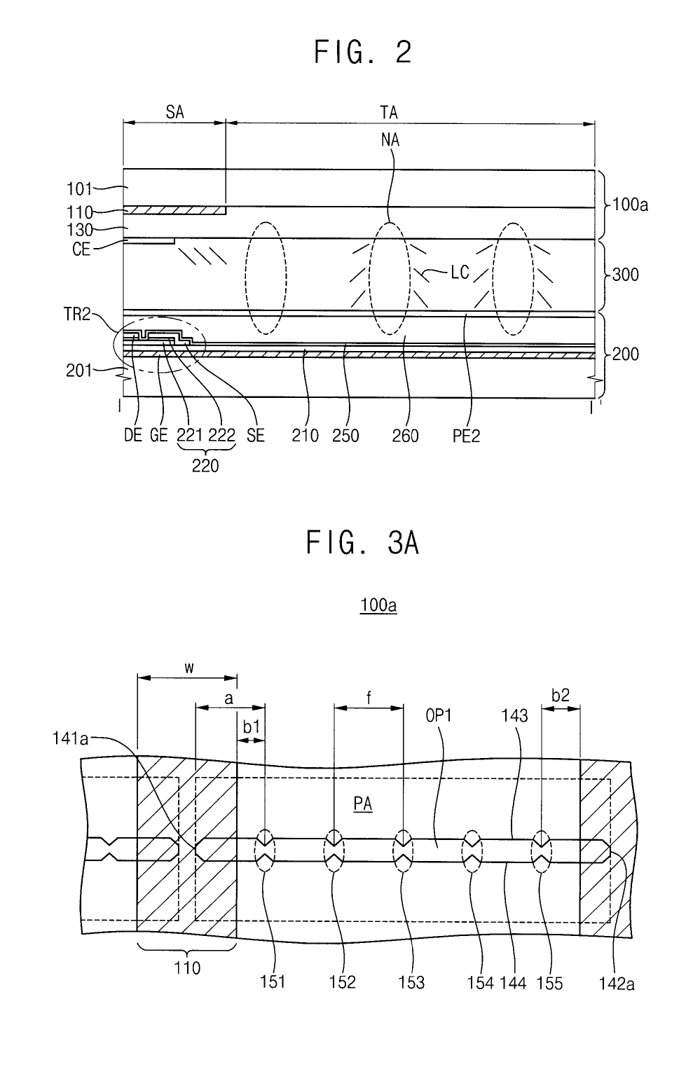

FIG. 1 is a plan view showing a display panel in accordance with one exemplary embodiment of the present invention. FIG. 2 is a cross-sectional view taken along line I-I′ shown in FIG. 1.

Referring to FIG. 1 and FIG. 2, the display panel includes a color filter substrate 100a, an array substrate 200, and a liquid crystal layer 300.

The color filter substrate 100a includes a first base substrate 101, a light-blocking layer 110, a color filter layer 130, and a common electrode CE. The light-blocking layer 110, the color filter layer 130, and the common electrode CE are disposed on the first base substrate 101. A transmission area TA and a light-blocking area SA are defined on the first base substrate 101. Light passes through the transmission area TA. Light is blocked in the light-blocking area SA. The light-blocking layer 110 is disposed in the light-blocking area SA and defines the transmission area TA of each pixel area PA1, PA2, and PA3. Each pixel area PA1, PA2, and PA3 has a long side along a longitudinal direction of the display panel and a short side along a horizontal direction of the display panel.

The color filter layer 130 is disposed in each pixel area PA1, PA2, and PA3. The color filter layer 130 includes red, green, and blue color filters. The color filters disposed in pixel areas arranged in the longitudinal direction have the same color, and the color filters disposed in pixel areas arranged in the horizontal direction have different colors. Alternatively, an overcoating layer (not shown) may be disposed on the color filter layer 130.

The common electrode CE is disposed on the color filter layer 130 and over the entire first base substrate 101, and a portion of the common electrode CE corresponding to each pixel area PA1, PA2, and PA3 is pattered to form an opening OP1. For example, the opening OP1 may be a slit. The opening OP1 divides the liquid crystal layer 300 in each pixel area PA1, PA2, and PA3 into multiple domains, and has a plurality of notch parts NC. Outermost notch parts 151 and 155 of the notch parts NC may be spaced apart from opposite sides of the opening OP1 and opposite sides of the light-blocking layer 110 by no more than 30 μm. Adjacent notch parts NC may be spaced apart from each other by no more than 45 μm.

The array substrate 200 includes a second base substrate 201, a gate line, a data line, a storage line, and a switching element. The gate line, the data line, the storage line, and the switching element are disposed on the second base substrate 201.

For example, a plurality of gate lines GLn−1, GLn, and GLn+1 extending in the longitudinal direction and a plurality of data lines DLm and DLm+1 extending in the horizontal direction are disposed on the second base substrate 201. The storage lines SL1 and SL2 are interposed between adjacent gate lines GLn−1, GLn, and GLn+1. For example, the data lines DLm and DLm+1 and the storage lines SL1 and SL2 may be disposed in the light-blocking area SA, and the gate lines GLn−1, GLn, and GLn+1 may be disposed in a region corresponding to the opening OP1.

The pixel areas PA1, PA2, and PA3 are defined on the second base substrate 201 on which the data lines DLm and DLm+1 and the storage lines SL1 and SL2 are disposed. A metal electrode, which may include the same metal material as the data lines DLm and DLm+1, is disposed on the storage lines SL1 and SL2 and overlaps with the storage lines SL1 and SL2.

The switching elements TR1, TR2, and TR3 are connected to the m^{th} data line DLm and the gate lines GLn−1, GLn, and GLn+1, respectively. Each switching element TR1, TR2, and TR3 includes a gate electrode GE, a channel pattern 220, a source electrode SE, and a drain electrode DE. The channel pattern 220 includes a semiconductor layer 221 and an ohmic contact layer 222.

For example, the first switching element TR1 is connected to the (n-1)^{th} gate line GLn−1 and the m^{th} data line DLm, and is disposed in the first pixel area PA1. The second switching element TR2 is connected to the n^{th} gate line GLn and the m^{th} data line DLm, and is disposed in the second pixel area PA2. The third switching element TR3 is connected to the (n+1)^{th} gate line GLn+1 and the m^{th} data line DLm, and is disposed in the third pixel area PA3. The first and second pixel areas PA1 and PA2 are adjacent to each other along the horizontal direction and are divided by the first storage line SL1. The second and third pixel areas PA2 and PA3 are adjacent to each other along the horizontal direction and are divided by the second storage line SL2.

A first pixel electrode PE1 is disposed in the first pixel area PA1, and is connected to the second switching element TR2 through a first contact hole H1 that is formed in the first pixel area PA1. A second pixel electrode PE2 is disposed in the second pixel area PA2, and is connected to the third switching element TR3 through a second contact hole H2 that is formed in the second pixel area PA2. A third pixel electrode PE3 is disposed in the third pixel area PA3, and is connected to a fourth switching element TR4 (not shown) through a third contact hole H3 that is formed in the third pixel area PA3. The fourth switching element TR4 is connected to an (n+2)^{th} gate line GLn+2 (not shown).

The array substrate 200 includes a gate insulating layer 210, a protective layer 250, and an organic insulating layer 260.

The liquid crystal layer 300 is disposed between the color filter substrate 100a and the array substrate 200. The liquid crystal layer 300 includes liquid crystal molecules LC. For example, the alignment of the liquid crystal molecules LC is changed by an electric field formed between the second pixel electrode PE2 and the common electrode CE. The electric field is distorted by the opening OP1 that is formed by patterning the common electrode CE, so that directors of the liquid crystal molecules LC are realigned to form multiple domains. A singular point SP formed in the region corresponding to the opening OP1 is controlled by notch parts NC. For example, the directors of the liquid crystal molecules LC are concentrated on a notch region NA in which the notch parts NC are formed, so that the singular point SP formed by the opening OP1 may be uniformly distributed.

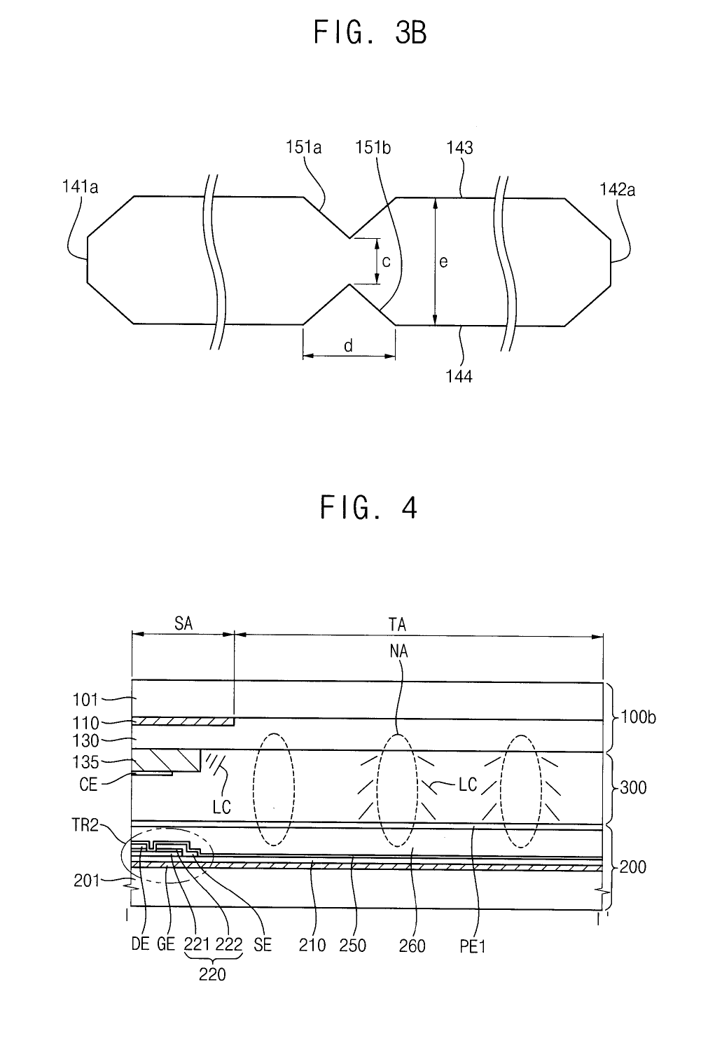

FIG. 3A and FIG. 3B are plan views showing the color filter substrate shown in FIG. 1.

Referring to FIG. 3A and FIG. 3B, the color filter substrate 100a has the opening OP1 corresponding to the pixel area PA. The opening OP1 extends along the long side of the pixel area PA, and has a left side 141a, a right side 142a corresponding to the left side 141a, an upper side 143, and a lower side 144 corresponding to the upper side 143. The left and right sides 141a and 142a are connected to each other by the upper and lower sides 143 and 144. First, second, third, fourth, and fifth notch parts 151, 152, 153, 154, and 155 are formed on the upper and lower sides 143 and 144. Each of the first, second, third, fourth, and fifth notch parts 151, 152, 153, 154, and 155 includes first and second notches 151a and 151b.

The first and fifth notch parts 151 and 155 are the outermost notch parts of the first, second, third, fourth, and fifth notch parts 151, 152, 153, 154, and 155, and are spaced apart from the left and right sides 141a and 142a of the opening OP1 by a first distance ‘a’, respectively. The first distance ‘a’ may be no more than 30 μm.

The first notch part 151 is spaced apart from a side of the light-blocking layer 110 that is disposed in a left portion of the pixel area PA by a left second distance b1. The left second distance b1 may be no more than about 10 μm. The fifth notch part 155 is spaced apart from a side of the light-blocking layer 110 that is disposed on the right portion of the pixel area PA by a right second distance b2. The right second distance b2 may be no more than 20 μm. For example, a width w of the light-blocking layer 110 may be 40 μm.

Each of the first and second notches 151a and 151b of the first notch part 151 has a triangular shape having a lower side along the upper and lower sides 143 and 144 and an apex protruding toward the center of the opening OP1. The apexes of the first and second notches 151a and 151b face each other, and are spaced apart from each other by a third distance c. The third distance c may be 3 μm to 8 μm. The width of each of the first and second notches 151a and 151b is a fourth distance d. The fourth distance d may be 3 μm to 13 μm.

The distance between the upper and lower sides 143 and 144 of the opening OP1 is a fifth distance e. The fifth distance e may be 5 μm to 15 μm. The first, second, third, fourth, and fifth notch parts 151, 152, 153, 154, and 155 are spaced apart from each other by a sixth distance f. The sixth distance f may be 30 μm to 45 μm, or more specifically, 32 μm to 33 μm. For example, the sixth distance f may be 32.75 μm.

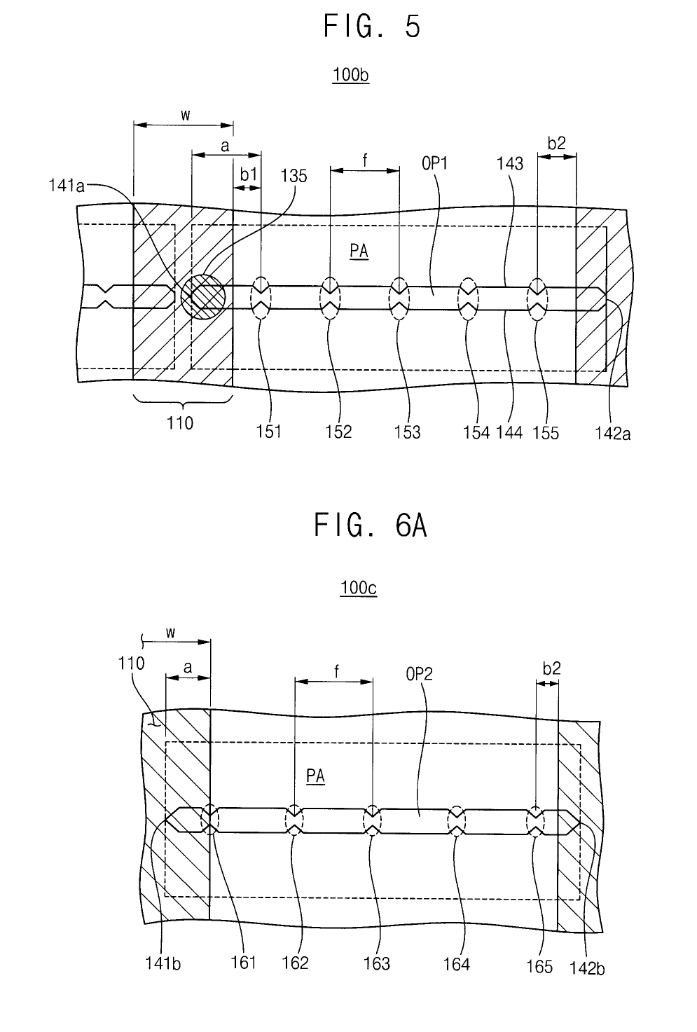

A display panel of FIG. 4 and FIG. 5 is substantially the same as in FIG. 1, FIG. 2, and FIG. 3 except for the color filter substrate. Thus, the same reference numerals will be used to refer to the same or like parts as those described in FIG. 1, FIG. 2, and FIG. 3 and any further explanation concerning the above elements will be omitted.

FIG. 4 is a cross-sectional view showing a display panel in accordance with another exemplary embodiment of the present invention. FIG. 5 is a plan view showing the color filter substrate shown in FIG. 4.

Referring to FIG. 4 and FIG. 5, the display panel includes a color filter substrate 100b, an array substrate 200, and a liquid crystal layer 300. The color filter substrate 100b includes a first base substrate 101, a light-blocking layer 110, a color filter layer 130, an island-shaped protrusion 135, and a common electrode CE.

A transmission area TA and a light-blocking area SA are defined on the first base substrate 101. The light-blocking layer 110 is disposed in the light-blocking area SA and defines the transmission area TA of each pixel area PA. The color filter layer 130 is disposed in the pixel area PA. The color filter layer 130 includes red, green, and blue color filters. The island-shaped protrusion 135 is disposed on the color filter layer 130 at a location corresponding to a location of the switching element TR2 of the array substrate 200.

The island-shaped protrusion 135 prevents light reflected from the light-blocking layer 110 from being incident into the switching element TR2, to prevent generation of a photocurrent in the switching element TR2, thereby improving electrical characteristics of the switching element TR2. A portion of liquid crystal molecules LC of the liquid crystal layer 300 is disposed in a stepped portion of the island-shaped protrusion 135, so that the portion of the liquid crystal molecules LC does not contact portions of the liquid crystal molecules LC near each notch part 151, 152, 153, 154, and 155 that are aligned toward the light blocking layer 110, so that a singular point SP is not formed in the liquid crystal layer 300.

The common electrode CE is disposed on the color filter layer 130, and a portion of the common electrode CE corresponding to each pixel area PA is pattered to form an opening OP1. For example, the opening OP1 extends in a longitudinal direction of the pixel area PA, and five notch parts 151, 152, 153, 154, and 155 are disposed in the opening OP1.

The notches of FIG. 4 and FIG. 5 are substantially the same as in FIG. 1, FIG. 2, and FIG. 3. Thus, the same reference numerals will be used to refer to the same or like parts as those described in FIG. 1, FIG. 2, and FIG. 3 and any further explanation concerning the above elements will be omitted.

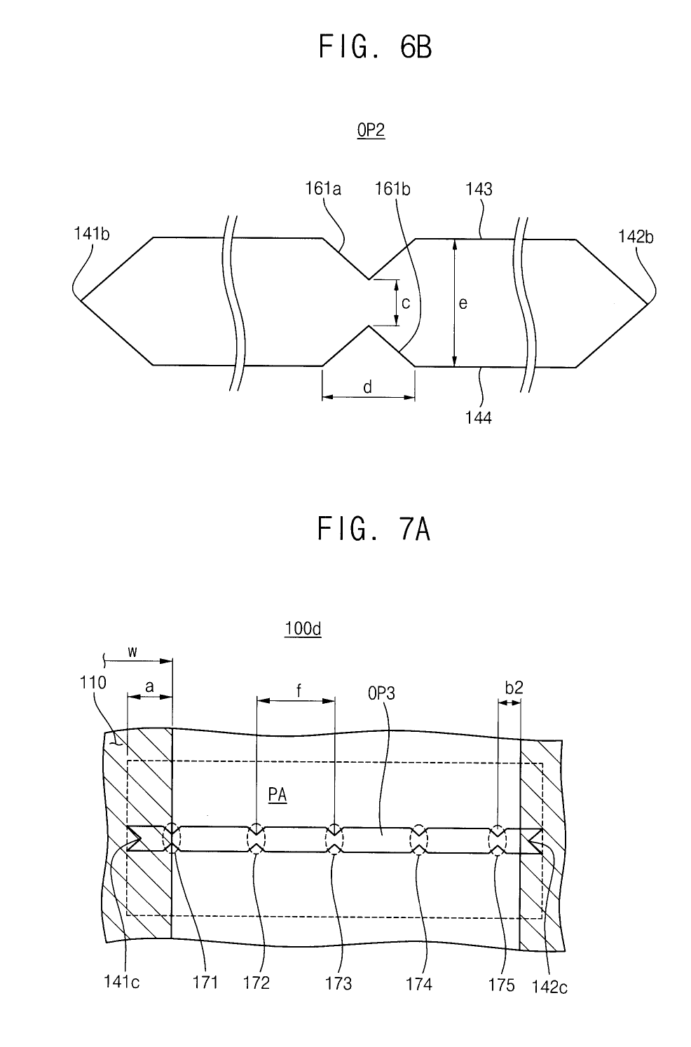

FIG. 6A and FIG. 6B are plan views showing a color filter substrate in accordance with still another exemplary embodiment of the present invention.

Referring to FIG. 6A and FIG. 6B, a color filter substrate 100c has a common electrode CE with an opening OP2 corresponding to a pixel area PA. The opening OP2 has a left side 141b, a right side 142b corresponding to the left side 141b, an upper side 143, and a lower side 144 corresponding to the upper side 143. Each of the left and right sides 141b and 142b has a substantially right triangular shape recessed from the center of the opening OP2. First, second, third, fourth, and fifth notch parts 161, 162, 163, 164, and 165 are disposed on the upper and lower sides 143 and 144. Each of the first, second, third, fourth, and fifth notch parts 161, 162, 163, 164, and 165 includes first and second notches 161a and 161b.

The first and fifth notch parts 161 and 165 are the outermost notch parts of the first, second, third, fourth, and fifth notch parts 161, 162, 163, 164, and 165, and are spaced apart from the left and right sides 141b and 142b of the opening OP2 by a first distance ‘a’, respectively. The first distance ‘a’ may be no more than 20 μm.

The first notch part 161 corresponds to a side of the light-blocking layer 110 that is disposed on the left portion of the pixel area PA, and a left second distance b1 between the first notch part 161 and the side of the light-blocking layer 110 may be 0 μm. The fifth notch part 165 is spaced apart from a side of the light-blocking layer 110 that is disposed on the right portion of the pixel area PA by a right second distance b2. The right second distance b2 may be no more than 10 μm.

Each of the first and second notches 161a and 161b of the first notch part 161 has a triangular shape having a lower side along the upper and lower sides 143 and 144 and an apex protruded toward the center of the opening OP2. The apexes of the first and second notches 161a and 161b face each other, and are spaced apart from each other by a third distance c. The third distance c may be 3 μm to 8 μm. The width of each of the first and second notches 161a and 161b is a fourth distance d. The fourth distance d may be 3 μm to 13 μm.

The distance between the upper and lower sides 143 and 144 of the opening OP2 is a fifth distance e. The fifth distance e may be 5 μm to 15 μm. The first, second, third, fourth, and fifth notch parts 161, 162, 163, 164, and 165 are spaced apart from each other by a sixth distance f. The sixth distance f may be 30 μm to 45 μm, or more specifically, 37 μm to 39 μm. For example, the sixth distance f may be 37.75 μm.

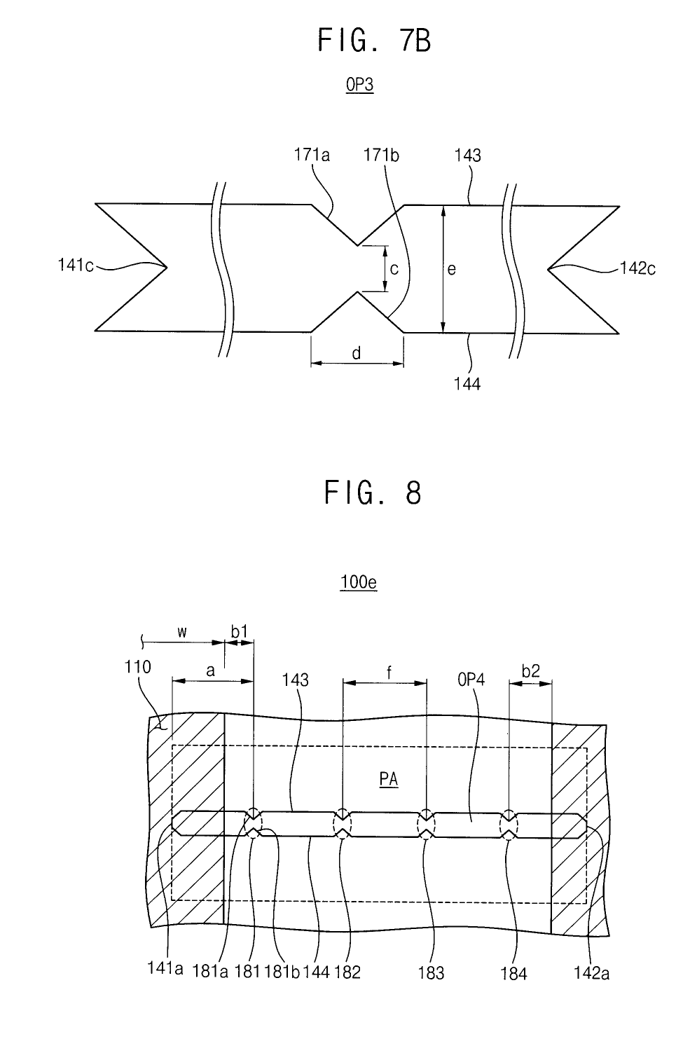

FIG. 7A and FIG. 7B are plan views showing a color filter substrate in accordance with further still another exemplary embodiment of the present invention.

Referring to FIG. 7A and FIG. 7B, a color filter substrate 100d has a common electrode CE with an opening OP3 corresponding to a pixel area PA. The opening OP3 has a left side 141c, a right side 142c corresponding to the left side 141c, an upper side 143, and a lower side 144 corresponding to the upper side 143. Each of the left and right sides 141c and 142c has a substantially right triangular shape protruded toward the center of the opening OP3. First, second, third, fourth, and fifth notch parts 171, 172, 173, 174, and 175 are disposed on the upper and lower sides 143 and 144. Each of the first, second, third, fourth, and fifth notch parts 171, 172, 173, 174, and 175 includes first and second notches 171a and 171b.

The first and fifth notch parts 171 and 175 are the outermost notch parts of the first, second, third, fourth, and fifth notch parts 171, 172, 173, 174, and 175 are spaced apart from the left and right sides 141c and 142c of the opening OP3 by a first distance ‘a’, respectively. The first distance ‘a’ may be no more than 20 μm.

The first notch part 171 corresponds to a side of the light-blocking layer 110 that is disposed on the left portion of the pixel area PA, and a left second distance b1 between the first notch part 171 and the side of the light-blocking layer 110 may be 0 μm. The fifth notch part 175 is spaced apart from a side of the light-blocking layer 110 that is disposed on the right portion of the pixel area PA by a right second distance b2. The right second distance b2 may be no more than 10 μm.

Each of the first and second notches 171a and 171b of the first notch part 171 has a triangular shape having a lower side along the upper and lower sides 143 and 144 and an apex protruded toward the center of the opening OP3. The apexes of the first and second notches 171a and 171b face each other, and are spaced apart from each other by a third distance c. The third distance c may be 3 μm to 8 μm. The width of each of the first and second notches 171a and 171b is a fourth distance d. The fourth distance d may be 3 μm to 13 μm.

The distance between the upper and lower sides 143 and 144 of the opening OP3 is a fifth distance e. The fifth distance e may be 5 μm to 15 μm. The first, second, third, fourth, and fifth notch parts 171, 172, 173, 174, and 175 are spaced apart from each other by a sixth distance f. The sixth distance f may be 30 μm to 45 μm, or more specifically, 37 μm to 39 μm. For example, the sixth distance f may be 37.75 μm.

FIG. 8 is a plan view showing a color filter substrate in accordance with further still another exemplary embodiment of the present invention.

Referring to FIG. 8, a color filter substrate 100e has a common electrode CE with an opening OP4 corresponding to a pixel area PA. The opening OP4 extends along a longitudinal direction of the pixel area PA, and has a left side 141a, a right side 142a corresponding to the left side 141a, an upper side 143, and a lower side 144 corresponding to the upper side 143. The left and right sides 141a and 142a are connected to each other by the upper and lower sides 143 and 144. First, second, third, and fourth notch parts 181, 182, 183, and 184 are disposed on the upper and lower sides 143 and 144. Each of the first, second, third, and fourth notch parts 181, 182, 183, and 184 includes first and second notches 181a and 181b. Although not shown in FIG. 8, the left and right sides may alternatively be formed with a protruded shape or with a recessed shape like those shown in FIG. 6A and FIG. 7A.

The first and fourth notch parts 181 and 184 are the outermost notch parts of the first, second, third, and fourth notch parts 181, 182, 183, and 184 and are spaced apart from the left and right sides 141a and 142a of the opening OP4 by a first distance ‘a’, respectively. The first distance ‘a’ may be no more than 30 μm.

The first notch part 181 is spaced apart from a side of the light-blocking layer 110 that is disposed on the left portion of the pixel area PA by a left second distance b1. The left second distance b1 may be no more than 10 μm. The fourth notch part 184 is spaced apart from a side of the light-blocking layer 110 that is disposed on the right portion of the pixel area PA by a right second distance b2. The right second distance b2 may be no more than 20 μm.

Each of the first and second notches 181a and 181b of the first notch part 181 has a triangular shape having a lower side along the upper and lower sides 143 and 144 and an apex protruded toward the center of the opening OP4. The apexes of the first and second notches 181a and 181b face each other, and are spaced apart from each other by a third distance c. The third distance c may be 3 μm to 8 μm. The width of each of the first and second notches 181a and 181b is a fourth distance d. The fourth distance d may be 3 μm to 13 μm.

The distance between the upper and lower sides 143 and 144 of the opening OP4 is a fifth distance e. The fifth distance e may be 5 μm to 15 μm. The first, second, third, and fourth notch parts 181, 182, 183, and 184 are spaced apart from each other by a sixth distance f. The sixth distance f may be 30 μm to 45 μm, or more specifically, 43 μm to 45 μm. For example, the sixth distance f may be 44 μm.

Table 1 represents color filter substrates and array substrates in accordance with the exemplary embodiments of the present invention. The color filter substrates of Table 1 were substantially the same as shown in FIG. 6A and FIG. 6B, and the array substrates of Table 1 were substantially the same as FIG. 2 and FIG. 4. In Table 1, the island pattern was formed from substantially the same layer as a blue color filter.

TABLE 1

| | Color Filter Substrate | | | | Array Substrate (TFT) | | |
|---|---|---|---|---|---|---|---|
| | | Island pattern | | | Nikon | | |
| Panel | 5 | Red | Green | Blue | Ver. 3 Mask | Active | a- |
| Number | notches | pixel | pixel | pixel | (Cst 20% up) | island | ITO |
| 1 | ◯ | ◯ | ◯ | X | ◯ | ◯ | ◯ |
| 2 | ◯ | ◯ | ◯ | ◯ | ◯ | ◯ | ◯ |
| 3 | ◯ | X | X | X | ◯ | ◯ | ◯ |

Referring to Table 1, the display panel 1 had a color filter substrate having five notches (shown in FIG. 6A) in each of red (R), green (G), and blue (B) pixels and an island-shaped protrusion 135 (shown in FIG. 4) in each of the R and G pixels. The island-shaped protrusion 135 was not formed in the B pixel of the color filter substrate of the display panel 1.

The display panel 2 had a color filter substrate having five notches (shown in FIG. 6A) in each of R, G, and B pixels and an island-shaped protrusion 135 (shown in FIG. 4) in each of the R, G, and B pixels.

The display panel 3 had a color filter substrate having five notches (shown in FIG. 6A) in each of R, G, and B pixels without an island-shaped protrusion 135 (shown in FIG. 4).

The TFT substrates of the display panel 1, the display panel 2, and the display panel 3 were substantially the same as the array substrate 200 shown in FIG. 1. The TFT substrate was formed through a five-mask method using five masks of a Nikon Version 3 Mask manufactured by Nikon Corp., Japan. The TFT substrate included an island-shaped semiconductor pattern and a pixel electrode including amorphous silicon and indium tin oxide (a-ITO), respectively.

Table 2 represents test results for inspecting spots of the display panels of Table 1.

TABLE 2

| Condition | Attaching | | Panel | Visual | Visual |
|---|---|---|---|---|---|
| Number | Polarizer | Baking | Number | Inspection | Test |
| 1 | Pressing | X | 1, 3 | OK (few spots) | OK |
| | single-sided | | | | |
| 2 | Pressing | 60° C. | 2, 3 | OK | OK |
| | double-sided | 10 min | | | |
| 3 | Pressing | 60° C. | 3 | OK | OK |
| | double-sided | 20 min | | (peripheral | |
| | | | | spots) | |
| 4 | Pressing | 60° C. | 2 | OK | OK |
| | double-sided | 1 hour | | | |
| | | 10 min | | | |

Referring to Table 2, under condition 1, a polarizer was attached to each of display panel 1 and display panel 3 by pressing on a single side, and a baking process was omitted. Spots were not displayed on the display panel 1 or the display 3 during the visual inspection and the visual test under condition 1.

Under condition 2, a polarizer was attached to each of the display panel 2 and the display panel 3 by pressing both sides of the polarizer and each of the display panel 2 and the display panel 3 and by baking the pressed polarizer and each of the display panel 2 and the display panel 3 at about 60° C. for about 10 minutes. Spots were not displayed on the display panel 2 or the display panel 3 during the visual inspection and the visual test under condition 2.

Under condition 3, a polarizer was attached to the display panel 3 by pressing both sides of the polarizer and the display panel 3 and by baking the pressed polarizer and the display panel 3 at about 60° C. for about 20 minutes. Although peripheral spots were displayed during the visual inspection, spots were not displayed on the display panel 3 during the visual inspection and the visual test under condition 3.

Under condition 4, a polarizer was attached to the display panel 2 by pressing both sides of the polarizer and the display panel 2 and by baking the pressed polarizer and the display panel 2 at about 60° C. for about 1 hour 10 minutes. Spots were not displayed on the display panel 2 during the visual inspection and the visual test under condition 4.

Thus, the display panel 3 having the five notches did not display spots.

Table 3 represents test results when afterimages of the display panels of Table 1 were inspected.

TABLE 3

| | Moving Image Type | | | |
|---|---|---|---|---|
| | | | | Check-pattern |
| | | | Random image | image of |
| | | Three-hole | -> check-pattern | grayscale value |
| | Bar pattern -> | pattern ->white | image -> white | of 200 -> white |
| Panel Number | white image | image | image | image |
| 1 | X | X | X | X |
| | (afterimage for 1 sec.: | (afterimage for 3 sec.: | (afterimage for 3 sec.: | |
| | one of 49 | two of 49 | one of 49 | |
| | frames) | frames) | frames) | |
| 2 | X | X | X | X |
| 3 | X | X | X | X |

Referring to Table 3, afterimages were tested using four types of moving images. In a first moving image, a bar pattern was changed to a white image. In a second moving image, a three-hole pattern was changed to a white image. In a third moving image, a random image, a check-pattern image, and a white image were sequentially displayed. In a fourth moving image, a check-pattern image of a grayscale value of 200 was changed to a white image.

In the display panel 1, an afterimage was displayed for one second at one frame of 49 frames with the first moving image. Also, an afterimage was displayed for three seconds at two frames of 49 frames with the second moving image. Furthermore, an afterimage was displayed for three seconds at one frame of 49 frames with the third moving image. Afterimages were not displayed with the fourth moving image.

In display panel 2 and display panel 3, afterimages were not displayed with the first, second, third, and fourth moving images.

In Table 3, the afterimages were negligible in the display panels of exemplary embodiments of the present invention. Although the afterimages were displayed on the display panels, the afterimages rapidly disappeared within three seconds. In exemplary embodiments of the present invention, the display panel included the outermost notches to efficiently control the liquid crystal molecules, thereby reducing the occurrence of afterimages.

According to exemplary embodiments of the present invention, a shape of an opening formed in a pixel area may be optimized to effectively control liquid crystal molecules, thereby decreasing the occurrence of spots and afterimages. For example, an outermost notch formed in the pixel area is spaced apart from an end portion of the opening and an end portion of a light-blocking layer, so that the liquid crystal molecules may be effectively controlled.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display panel, comprising:
an array substrate comprising a pixel electrode disposed in a pixel area and a switching element connected to the pixel electrode, the pixel area having a longitudinal side along a longitudinal direction of the array substrate and a horizontal side along a horizontal direction of the array substrate; and
a color filter substrate combined with the array substrate, the color filter substrate comprising:
a light-blocking layer defining a transmission area corresponding to the pixel area;
a color filter layer disposed on the light-blocking layer; and
a common electrode disposed on the color filter layer, the common electrode having an opening disposed in the pixel area and extending along the longitudinal direction, the opening having a left side, a right side, an upper side, and a lower side and a plurality of notch parts at the upper side and the lower side, an outermost notch part being spaced apart from the left side or the right side by 20 μm to 30 μm.

2. The display panel of claim 1, wherein the color filter substrate further comprises an island-shaped protrusion disposed on the color filter layer, a location of the island-shaped protrusion corresponding to a location of the switching element.

3. The display panel of claim 1, wherein the notch parts are spaced apart from each other by 30 μm to 45 μm.

4. The display panel of claim 1, wherein the upper side is spaced apart from the lower side by 5 μm to 15 μm.

5. The display panel of claim 1, wherein each of the notch parts comprises a first notch recessed from the upper side toward a center of the opening and a second notch recessed from the lower side toward the center of the opening, and
wherein an apex of the first notch is spaced apart from an apex of the second notch by 3 μm to 8 μm.

6. The display panel of claim 1, wherein the number of the notch parts is 4 or 5.

7. The display panel of claim 1, wherein both of the left side and the right side of the opening have either a recessed shape or a protruded shape.

8. The display panel of claim 1, wherein the outermost notch part is spaced apart from the left side or the right side by 20 μm.

9. A display panel, comprising:
an array substrate comprising a pixel electrode disposed in a pixel area and a switching element connected to the pixel electrode, the pixel area having a longitudinal side along a longitudinal direction of the array substrate and a horizontal side along a horizontal direction of the array substrate; and
a color filter substrate combined with the array substrate, the color filter substrate comprising:
a light-blocking layer defining a transmission area corresponding to the pixel area;
a color filter layer disposed on the light-blocking layer; and
a common electrode disposed on the color filter layer, the common electrode having an opening disposed in the pixel area and extending along the longitudinal direction, the opening having a left side, a right side, an upper side, and a lower side and a plurality of notch parts at the upper side and the lower side, both of the left side and the right side of the opening having either a recessed shape or a protruded shape.

10. The display panel of claim 9, wherein the color filter substrate further comprises an island-shaped protrusion disposed on the color filter layer, a location of the island-shaped protrusion corresponding to a location of the switching element.

11. The display panel of claim 9, wherein the notch parts are spaced apart from each other by 30 μm to 45 μm.

12. The display panel of claim 9, wherein the upper side is spaced apart from the lower side by 5 μm to 15 μm.

13. The display panel of claim 9, wherein each notch part comprises a first notch recessed from the upper side toward a center of the opening and a second notch recessed from the lower side toward the center of the opening, and
an apex of the first notch is spaced apart from an apex of the second notch by 3 μm to 8 μm.

14. The display panel of claim 9, wherein the number of the notch parts is 4 or 5.

15. The display panel of claim 9, wherein the outermost notch part is spaced apart from the left side or the right side by 20 μm.

16. A display panel, comprising:
an array substrate comprising a pixel electrode disposed in a pixel area and a switching element connected to the pixel electrode, the pixel area having a longitudinal side along a longitudinal direction of the array substrate and a horizontal side along a horizontal direction of the array substrate; and
a color filter substrate combined with the array substrate, the color filter substrate comprising:
a light-blocking layer defining a transmission area corresponding to the pixel area;
a color filter layer disposed on the light-blocking layer;
a common electrode disposed on the color filter layer, the common electrode having an opening disposed in the pixel area and extending along the longitudinal direction, the opening having a left side, a right side, an upper side, and a lower side and a plurality of notch parts at the upper side and the lower side; and
an island-shaped protrusion disposed on the color filter layer and at a location corresponding to a location of the switching element.

17. The display panel of claim 16, wherein the notch parts are spaced apart from each other by 30 μm to 45 μm.

18. The display panel of claim 16, wherein the upper side is spaced apart from the lower side by 5 μm to 15 μm.

19. The display panel of claim 16, wherein each of the notch parts comprises a first notch recessed from the upper side toward the center of a opening and a second notch recessed from the lower side toward the center of the opening, and
an apex of the first notch is spaced apart from an apex of the second notch by 3 μm to 8 μm.

20. The display panel of claim 16, wherein the outermost notch part is spaced apart from the left side or the right side by 20 μm.
